(19) United States
(12) Patent Application Publication
(10) Pub. No.: US 2005/0057503 A1
(43) Pub. Date: Mar. 17, 2005

(54) Mouse click prevention device

(76) Inventor: Vikki D. Shelton, Virginia Beach, VA (US)

Correspondence Address: STITES & HARBISON PLLC, 1199 NORTH FAIRFAX STREET, SUITE 900, ALEXANDRIA, VA, 22314, US

(21) Appl. No.: 10/647,375

(22) Filed: Aug. 26, 2003

(51) Int. Cl. G09G 5/08

(52) U.S. Cl. 345/163

(57) ABSTRACT

A device is provided for preventing operation of the right operating button of a computer mouse. In a conventional mouse, a lower edge of the right operating button is normally spaced from a base portion of the mouse by a gap therebetween. The device includes an operation prevention member separate from the computer mouse and having an edge portion of a thickness permitting insertion of the edge portion in this gap so as to prevent depressing of the right operating button. An attachment arrangement, including a slotted attachment annulus connected to the operation prevention member, removably attaches the operation prevention member to the electrical power cord of the mouse. Preferably, the operation prevention member is a substantially planar member of a roughly L-shaped configuration, as viewed in plan, and including a laterally extending gripping tab.

### FIELD OF THE INVENTION

The present invention relates to the operation of a computer control device commonly known as a mouse and, more particularly, to a device for selectively preventing operation of the right operational member or operating button of such a mouse.

### BACKGROUND OF THE INVENTION AND RELATED ART

Anyone who has been around small children and computers knows that many children are fascinated by computers and delight in pushing on the operating buttons or “clickers” of the computer mouse and watching the screen display change. The problem with this is that depressing on the right operating button can change the previously selected application properties and generally create problems that can be difficult to undo. It will be appreciated that such operation by a child (or another) of the left operating button is much less of a problem since the left button basically effects select functions.

Applicant has become aware of Japanese Patent No. P2002-222047A which discloses an “input preventative structure” for a mouse for “temporarily preventing input operation of a mouse.” The device includes, built therein, a movable “deterrence member” which is slidable along the reverse surface of an input operation button to a position wherein the tip of a “lock piece” is inserted between the reverse surface of the button and the upper end of the front end wall of the main mouse body. The deterrence member is slidable in the opposite direction to enable the input operation button to be operated.

The approach disclosed in the Japanese patent is used for disabling of both operating buttons, and in the embodiment employing the slidable deterrence member, provides disablement of both buttons at the same time. Very importantly, this approach requires structured redesign or reconstruction of the mouse since the control is built into the mouse itself.

Because of the problems discussed above, a need exists for a simple device, which does not require redesign, reconstruction or other modification of a conventional mouse, to positively prevent operation of the right operating button of a mouse so as to prevent children and others from depressing or otherwise operating the right button whether through inadvertence, through an intentional but unknowing action or otherwise.

### SUMMARY OF THE INVENTION

In accordance with the invention, a device is provided which can be used to disable, or otherwise prevent the operation of, the right operating button of a mouse. The operation prevention device of the invention is completely separate from the mouse and can be used with any mouse without any modification of the mouse. The device is simple yet very effective and, as will appear, includes a number of advantageous features which enhance its usefulness and effectiveness.

In accordance with a first aspect of the invention, there is provided a device for, in use, preventing operation of a right operating button of a computer mouse. As is conventional, a lower edge of the right operating button of the mouse is spaced from a base portion of the mouse by a gap therebetween when the right operating button is inoperative. The device of this aspect of the invention comprises an operation prevention member separate from the computer mouse and having an edge portion of a thickness permitting insertion of the edge portion in the gap between the lower edge of the right operating button of the mouse and the base portion of the mouse so as to prevent operation of the right operating button. The edge portion of the operation prevention member includes a first edge part adapted to engage an end portion of the gap and a second edge part extending generally orthogonally to the first edge part and being adapted to engage a side portion of the gap.

As is conventional, the mouse also includes an electrical cord for connecting the mouse to a power source, and, preferably, the operation prevention device further comprises attachment means for removably attaching the operation prevention member to the electrical cord. The attachment means advantageously includes an attachment member and an elongate connecting element for connecting the operation prevention member to the attachment member. In a preferred embodiment, the attachment member comprises an annular member having a central opening therein of a diameter that enables the electrical cord to be received in the central opening, the annular member further including a radial slit therein that enables the annular member to be fit onto the electrical cord.

In a preferred implementation, the operation prevention member comprises a substantially planar member.

Preferably, the operation prevention member also includes a gripping tab portion.

In a preferred embodiment, the operation prevention member comprises a substantially planar member of a generally L-shaped configuration as viewed in plan, the L-shaped configuration including a first leg including said first edge part and a second orthogonal leg including said second edge part, said second leg further including a gripping tab extending laterally outwardly therefrom in a direction away from said second edge part.

In accordance with a second related aspect of the invention, there is provided a device for, in use, preventing operation of a right operating button of a computer mouse. As set forth above, a lower edge of the right operating button of the mouse is normally spaced from a base portion of the mouse by a gap therebetween and the mouse includes an electrical cord for connecting the mouse to an electrical power source. In this aspect, the said device comprises an operation prevention member separate from the computer mouse and having an edge portion of a thickness permitting insertion of the edge portion in the gap between the lower edge of the right operating button of the mouse and the base portion of the mouse so as to prevent depressing of the right operating button; and attachment means for removably attaching the operation prevention member to the electrical cord.

As above, the attachment means preferably includes an attachment member and an elongate connecting element for connecting the operation prevention member to the attachment member, and in a preferred embodiment, the attachment member comprises an annular member having a central opening therein of a diameter that enables the electrical cord to be received in said central opening, the annular member further including a radial slit therein that enables the annular member to be fit onto the electrical cord.

As in the first aspect, the operation prevention member comprises a substantially planar member.

Similarly, the operation prevention member also further includes a gripping tab portion.

In a preferred implementation, the edge portion of the operation prevention member includes a first edge part adapted to engage an end portion of the gap and a second edge part extending generally orthogonally to said first edge part and being adapted to engage a side portion of the gap. In a preferred embodiment of this implementation, the operation prevention member comprises a substantially planar member of a generally L-shaped configuration as viewed in plan, the L-shaped configuration including a first leg including said first edge part and a second orthogonal leg including said second edge part, the second leg including a gripping tab extending laterally outwardly therefrom in a direction away from said second edge part.

In accordance with a third, related aspect of the invention, there is provided a device for, in use, preventing operation of a right operating button of a computer mouse. As before, and is conventional, a lower edge of the right operating button is spaced from a base portion of the mouse by a gap therebetween when the right operating button is inoperative. The device of this aspect comprises an operation prevention member separate from the computer mouse and having an edge portion of a thickness permitting insertion of the edge portion in the gap between the lower edge of the right operating button of the mouse and the base portion of the mouse so as to prevent depression of the right operation button. The edge portion of the operation prevention member includes a first edge part adapted to engage an end portion of the gap and a second part extending generally orthogonally to said first part and adapted to engage a side portion of the gap. The operation prevention member is fabricated of plastic and comprises a substantially planar member of a generally L-shaped configuration, as viewed in plan. The L-shaped configuration includes a first leg including said first edge part and a second orthogonal leg including said second edge part. The second leg includes a gripping tab portion extending laterally outwardly therefrom, in a common plane therewith, and in a direction away from the second edge part.

Again, as is conventional, the mouse includes an electrical cord for connecting the mouse to a power source, and in a preferred embodiment of this aspect, the device further comprises attachment means for removably attaching the operation prevention member to the electrical cord. As before, the attachment means preferably includes an attachment member and an elongate connecting element for connecting the operation prevention member to the attachment member, and in a preferred implementation, the attachment member comprises an annular member having a central opening therein of a diameter that enables the electrical cord to be received in said central opening, the annular member further including a radial slit therein that enables the annular member to be fit onto the electrical cord.

Further features and advantages of the present invention will be set forth in, or apparent from, the detailed description of preferred embodiments thereof which follows.

### BRIEF DESCRIPTION OF THE DRAWINGS

FIG. 1 is a mouse operation prevention device in accordance with a preferred embodiment of the invention;

FIG. 2 is a plan view of the device of FIG. 1, with the connector portion thereof omitted;

FIG. 3 is a top plan view of a mouse showing the device of FIG. 1 about to be put into use; and

FIG. 4 is an end elevational view of the mouse of FIG. 3 showing the device of FIG. 1 in use.

### DESCRIPTION OF THE PREFERRED EMBODIMENTS

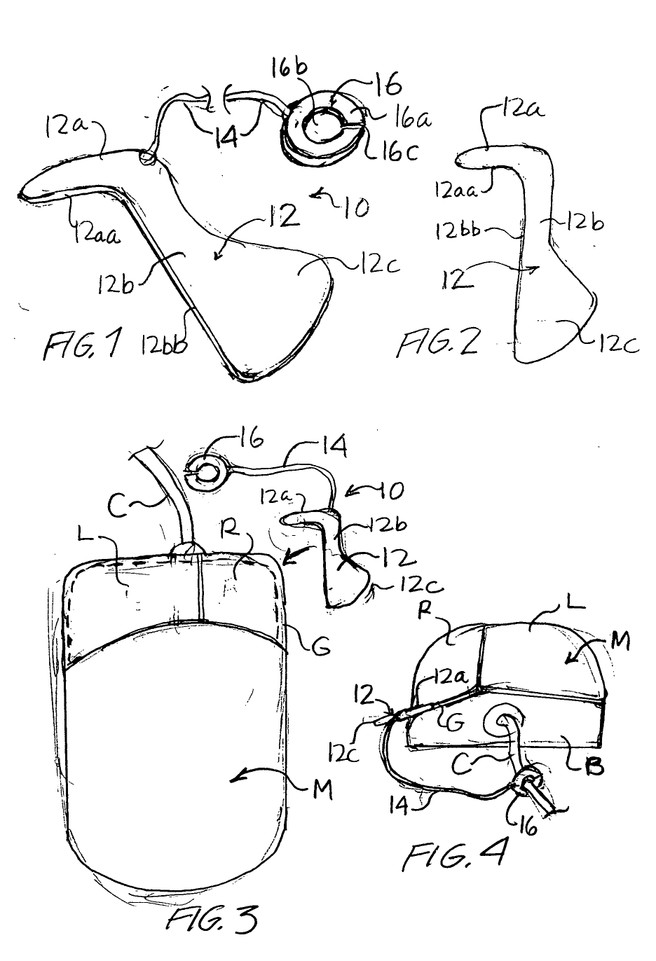

Referring to FIGS. 1 and 2, a preferred embodiment of the device of the invention is shown. The overall device is denoted 10. The principal part of the device comprises a generally flat or planar operation prevention member 12. Member 12, which is also referred to herein as a protective member, is preferably made of plastic although other materials can also be used.

As indicated in FIG. 1, member 12 is relatively thin and, more specifically, is of a thickness such as to enable member 12 to fit into the space or gap between the lower edge of the right operating button of a mouse and the mating edge of a base portion of the mouse that is engaged by the lower edge of the right operating button when the button is depressed, as is described in more detail below.

In the embodiment illustrated, member 12 is of a roughly L-shaped configuration and includes an upper head or projecting portion 12a and a generally orthogonally extending base portion 12b. Base portion 12b includes a finger tab 12c which projects oppositely from head or projecting portion 12b and is sized to be gripped by the fingers of a user.

As illustrated, head portion 12a includes a substantially straight inner edge 12aa while base portion 12b includes a substantially straight inner edge 12bb which extends substantially orthogonally to edge 12aa.

An elongate connecting element 14 connects protective member 12 to an attachment member 16 (not shown in FIG. 2) for attaching or affixing member 12 to the electrical cord of a mouse, as is also described in more detail below. In the illustrated embodiment, attachment member 16 comprises a general circular or annular element 16a which defines a central opening 16b and which includes therein a radial slit 16c that enables attachment member 16 to be fit around the electrical cord for a mouse by pulling apart the portions of annulus 16a adjacent to slit 16c and fitting the cord into opening 16b. Although this simple method of attachment is preferred, it will be appreciated that other different means for attaching protective member 12 to a mouse can be provided.

The connecting arrangement or connecting means comprised of connecting element 14 and attachment or affixing member 16 provides at least two important advantages. First, it prevents the relatively small protective member 12 from getting lost or being inadvertently misplaced when the connecting arrangement is in place. Further, the combination of the connecting arrangement with the protective member 12 makes swallowing of the device 10 by a small child less of a problem than would be the case with protective member 12 alone. However, it will be understood that member 10 has utility by itself and can be provided and used without an associated connecting arrangement or connecting means.

It is also to be understood that the showing of the various members and elements in the drawings is not to scale and that the relative sizes of protective member 12 and attachment member 16 may be different from that shown.

Referring to FIGS. 3 and 4, there is shown a typical conventional computer mouse M including a left operating button L and a right operating button R. The mouse M also includes an associated electrical cord C for connecting to mouse M to an electrical wall outlet or other power source. As is conventional, and is shown in FIG. 4 (and indicated in dashed lines in FIG. 3), a gap or space G is created between a lower edge of right operating button R and an upper edge portion of the end and side walls of the base or main body part, denoted B, of mouse M.

As was described above and is shown in FIGS. 3 and 4, device 10 is used to prevent or block operation of right button R and, to this end, the edge portions of protective member 12 are inserted into gap G so that button R cannot be depressed or otherwise actuated. It will be appreciated that edge or edge part 12aa of member 12 is received in the end wall portion of gap G while edge or edge part 12bb is received in the side wall portion of gap G.

When the right operating button R of the mouse M is to again be used, and thus member 12 is no longer needed, tab 12c can be gripped by the fingers of the user to remove member 12 from gap G. Further, if desired, the entire device can be removed by detaching or disconnecting attachment member 16.

As indicated above, attachment member 16 is normally secured to the electrical cord C so that protective member 12 is not misplaced when removed from gap G, although, as just indicated above, the entire device 10 can be removed when desired.

It will be appreciated that although most mouse types are of a roughly rectangular shape, most also include curves and/or fillets to streamline the shape thereof and thus, for example, the gap G may include inclined portions as shown and may be curved to some extent. The illustrated embodiment of operation protection member 12 will fit the associated gaps or spacings (corresponding to gap G) of most conventional mouse types but the shape of member 12 can, of course, be modified to fit special mouse types as needed.

Although the invention has been described above in relation to preferred embodiments thereof, it will be understood by those skilled in the art that variations and modifications can be effected in these preferred embodiments without departing from the scope and spirit of the invention.

1. A device for, in use, preventing operation of a right operating button of a computer mouse, a lower edge of the right operating button being spaced from a base portion of the mouse by a gap therebetween when the right operating button is inoperative, and said device comprising:
an operation prevention member separate from the computer mouse and having an edge portion of a thickness permitting insertion of the edge portion in the gap between the lower edge of the right operating button of the mouse and the base portion of the mouse so as to prevent operation of the right operating button, said edge portion of the operation prevention member including a first edge part adapted to engage an end portion of the gap and a second edge part extending generally orthogonally to said first edge part and being adapted to engage a side portion of the gap.

2. A device as claimed in claim 1, wherein the mouse includes an electrical cord for connecting the mouse to a power source, and said device further comprises attachment means for removably attaching the operation prevention member to the electrical cord.

3. A device as claimed in claim 2 wherein said attachment means includes an attachment member and an elongate connecting element for connecting the operation prevention member to the attachment member.

4. A device as claimed in claim 3 wherein the attachment member comprises an annular member having a central opening therein of a diameter that enables the electrical cord to be received in said central opening, said annular member further including a radial slit therein that enables the annular member to be fit onto the electrical cord.

5. A device as claimed in claim 1 wherein said operation prevention member comprises a substantially planar member.

6. A device as claimed in claim 1 wherein said operation prevention member includes a gripping tab portion.

7. A device as claimed in claim 1 wherein said operation prevention member comprises a substantially planar member of a generally L-shaped configuration as viewed in plan, said L-shaped configuration including a first leg including said first edge part and a second orthogonal leg including said second edge part, said second leg further including a gripping tab extending laterally outwardly therefrom in a direction away from said second edge part.

8. A device for, in use, preventing operation of a right operating button of a computer mouse, a lower edge of the right operating button being normally spaced from a base portion of the mouse by a gap therebetween and the mouse including an electrical cord for connecting the mouse to an electrical power source, said device comprising:
an operation prevention member separate from the computer mouse and having an edge portion of a thickness permitting insertion of the edge portion in the gap between the lower edge of the right operating button of the mouse and the base portion of the mouse so as to prevent depressing of the right operating button; and
attachment means for removably attaching the operation prevention member to the electrical cord.

9. A device as claimed in claim 8 wherein said attachment means includes an attachment member and an elongate connecting element for connecting the operation prevention member to the attachment member.

10. A device as claimed in claim 9 wherein the attachment member comprises an annular member having a central opening therein of a diameter that enables the electrical cord to be received in said central opening, said annular member further including a radial slit therein that enables the annular member to be fit onto the electrical cord.

11. A device as claimed in claim 8 wherein said operation prevention member comprises a substantially planar member.

12. A device as claimed in claim 8 wherein said operation prevention member includes a gripping tab portion.

13. A device as claimed in claim 12 wherein said edge portion of the operation prevention member includes a first edge part adapted to engage an end portion of the gap and a second edge part extending generally orthogonally to said first edge part and being adapted to engage a side portion of the gap.

14. A device as claimed in claim 13 wherein said operation prevention member comprises a substantially planar member of a generally L-shaped configuration as viewed in plan, said L-shaped configuration including a first leg including said first edge part and a second orthogonal leg including said second edge part, said second leg including a gripping tab extending laterally outwardly therefrom in a direction away from said second edge part.

15. A device for, in use, preventing operation of a right operating button of a computer mouse, a lower edge of the right operating button being spaced from a base portion of the mouse by a gap therebetween when the right operating button is inoperative, and said device comprising:
an operation prevention member separate from the computer mouse and having an edge portion of a thickness permitting insertion of the edge portion in the gap between the lower edge of the right operating button of the mouse and the base portion of the mouse so as to prevent depression of the right operation button, said edge portion of the operation prevention member including a first edge part adapted to engage an end portion of the gap and a second part extending generally orthogonally to said first part and adapted to engage a side portion of the gap,
said operation prevention member being fabricated of plastic and comprising a substantially planar member of a generally L-shaped configuration, as viewed in plan, and including a first leg including said first edge part and a second orthogonal leg including said second edge part, said second leg including a gripping tab portion extending laterally outwardly therefrom, in a common plane therewith, and in a direction away from said second edge part.

16. A device as claimed in claim 15, wherein the mouse includes an electrical cord for connecting the mouse to a power source, and said device further comprises attachment means for removably attaching the operation prevention member to the electrical cord.

17. A device as claimed in claim 16 wherein said attachment means includes an attachment member and an elongate connecting element for connecting the operation prevention member to the attachment member.

18. A device as claimed in claim 16 wherein the attachment member comprises an annular member having a central opening therein of a diameter that enables the electrical cord to be received in said central opening, said annular member further including a radial slit therein that enables the annular member to be fit onto the electrical cord.
